(19) United States
(12) Patent Application Publication
(10) Pub. No.: US 2025/0308747 A1
(43) Pub. Date: Oct. 2, 2025

(54) GRANULATED POWDER AND INDUCTOR

(71) Applicant: Murata Manufacturing Co., Ltd., Kyoto-fu (JP)

(72) Inventor: Yoshinobu KIMURA, Nagaokakyo-shi (JP)

(73) Assignee: Murata Manufacturing Co., Ltd., Kyoto-fu (JP)

(21) Appl. No.: 19/016,672

(22) Filed: Jan. 10, 2025

(30) Foreign Application Priority Data
Mar. 27, 2024 (JP) 2024-051498

(51) Int. Cl. H01F 27/255; H01F 27/29

(52) U.S. Cl. CPC H01F 27/255; H01F 27/29

(57) ABSTRACT

A granulated powder contains granulated particles granulated using metal magnetic particles and a base ingredient and a curing agent in a predetermined weight ratio that are to form a thermosetting resin, and the metal magnetic particles include first magnetic particles and second magnetic particles with different average particle diameters. The granulated particles have a D10 particle diameter of 15 μm or more and a D90 particle diameter of 150 μm or less, and the percentage decrease in the Celsius temperature at which the granulated powder reaches its heat flow peak in differential scanning calorimetry compared to the Celsius temperature at which the resin immediately after the mixing of the base ingredient and the curing agent in the predetermined weight ratio reaches its heat flow peak in differential scanning calorimetry is 10% or less.

### CROSS-REFERENCE TO RELATED APPLICATION

This application claims benefit of priority to Japanese Patent Application No. 2024-051498, filed Mar. 27, 2024, the entire content of which is incorporated herein by reference.

### BACKGROUND

### Technical Field

The present disclosure relates to a granulated powder containing metal magnetic particles for use in the manufacture of inductors, and to an inductor made using the granulated powder.

### Background Art

In Japanese Unexamined Patent Application Publication No. 2006-206944, a method for manufacturing granulated powder is disclosed in which granulation is performed by spraying a binder solution from an upper portion side of a fluidized bed container while allowing raw-material powder stored in the fluidized bed container to tumble and flow using gas introduced from a lower portion of the fluidized bed container. In this manufacturing method, the particle size distribution of the granulated powder is narrowed by increasing the flow velocity of the introduced gas in a second stage of the granulation step compared to the flow velocity in a first stage.

In Japanese Unexamined Patent Application Publication No. 2014-143286, it is described that granulated powder is formed by crushing a clumpy dry substance obtained by drying a mixture of soft magnetic alloy powder and a binding material, the granulated powder is molded using a mold to give a molded body, and then the binding material is cured by heating the molded body to give a powder magnetic core.

### SUMMARY

Manufacturing variations in the shape of magnetic cores produced by loading granulated powder into a mold and heating and pressure-molding the powder, as well as the density of the magnetic cores, can depend on the repeatability of the weight of the granulated powder loaded into the mold and the flowability of resin in the granulated powder during heating and pressure molding.

Accordingly, the present disclosure provides a granulated powder that can be loaded into a mold for molded bodies with high repeatability in weight and with which the density of molded bodies produced through heating and pressing inside a mold can be improved, as well as an inductor made using the granulated powder.

An aspect of the present disclosure is a granulated powder containing granulated particles granulated using metal magnetic particles and a base ingredient and a curing agent in a predetermined weight ratio that are to form a thermosetting resin. The metal magnetic particles include first magnetic particles and second magnetic particles with different average particle diameters. The granulated particles contained in the granulated powder have a D10 particle diameter of 15 μm or more and a D90 particle diameter of 150 μm or less, and a percentage decrease in a Celsius temperature at which the granulated powder reaches a heat flow peak in differential scanning calorimetry compared to a Celsius temperature at which a resin immediately after mixing of the base ingredient and the curing agent in the predetermined weight ratio reaches a heat flow peak in differential scanning calorimetry is 10% or less.

An inductor including a molded body produced by pressure-molding the granulated powder, a coil conductor embedded in the molded body, and a pair of outer electrodes electrically coupled to the coil conductor.

According to the present disclosure, there can be provided a granulated powder that can be loaded into a mold for molded bodies with high repeatability in weight and with which the density of molded bodies produced through heating and pressing inside a mold can be improved, as well as an inductor made using the granulated powder.

### BRIEF DESCRIPTION OF THE DRAWINGS

FIG. 1 is a perspective view in which an inductor according to an embodiment of the present disclosure is seen from its upper surface side;

FIG. 2 is a perspective view in which the inductor is seen from its bottom surface side;

FIG. 3 is a transparent perspective view illustrating the internal structure of the inductor;

FIG. 4 is a diagram illustrating a process for manufacturing an inductor;

FIG. 5 is a perspective view illustrating the structure of a first tablet, which is a preform;

FIG. 6 is a plan view of the first tablet illustrated in FIG. 5;

FIG. 7 is a schematic view illustrating the structure of granulated particles contained in granulated powder;

FIG. 8 is an explanatory view for describing a method for manufacturing granulated powder;

FIG. 9 is a diagram schematically illustrating DSC curves, obtained in differential scanning calorimetry, of granulated powder and a same-composition resin; and

FIG. 10 is a diagram illustrating the relationship between the percentage decrease in the peak temperature of granulated powder and the density of molded bodies produced using the granulated powder.

### DETAILED DESCRIPTION

The characteristics and manufacturing variations of magnetic cores produced by loading a granulated powder containing metal particles and resin into a mold and heating and pressure-molding the powder are influenced by the nature and condition of the granulated powder that is the raw material for the magnetic cores.

The inventor conducted extensive research on the characteristics and conditions that the granulated powder should have, particularly from the viewpoint of improving the manufacturing shape stability and density of magnetic cores produced through the heating and pressure molding of the granulated powder as described above, and has arrived at the present disclosure.

In the following, embodiments of the present disclosure will be described with reference to drawings.

### 1. Inductor

First, an example of a structure of an inductor created using granulated powder as the raw material for its magnetic core and an example of a process for manufacturing it will be described.

### 1.1. Structure of the Inductor

An inductor created using granulated powder as a raw material for its magnetic core is, for example, a chip inductor created substantially in the shape of a hexahedron.

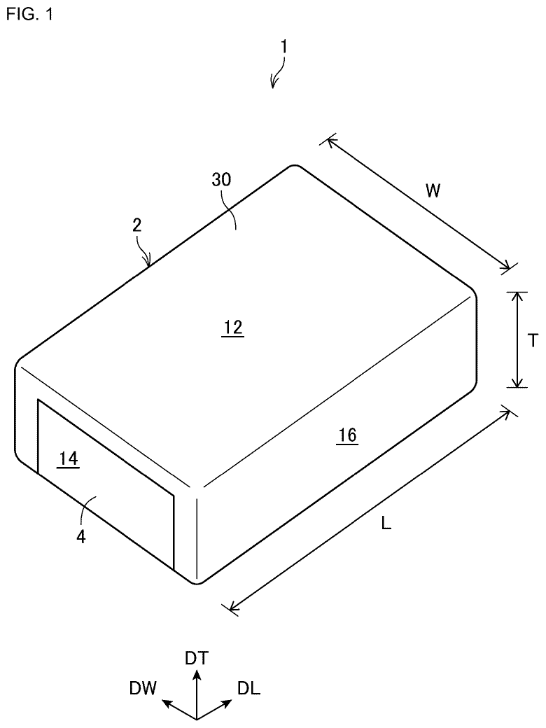

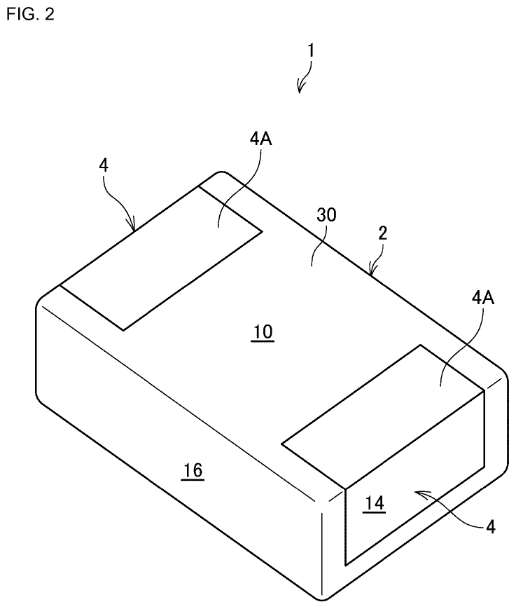

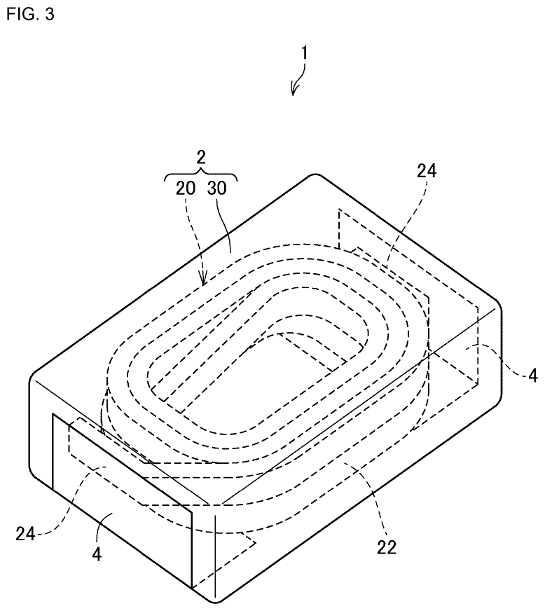

FIG. 1, FIG. 2, and FIG. 3 are diagrams illustrating the overall structure of an inductor 1 according to an embodiment.

FIG. 1 is a perspective view in which the inductor 1 is seen from its upper surface 12 side, and FIG. 2 is a perspective view in which the inductor 1 is seen from its bottom surface 10 side.

The inductor 1 according to this embodiment is configured as an electronic component of surface mount type and includes a body 2 in a substantially rectangular parallelepiped shape, which is one form of a substantially hexahedral shape, and a pair of outer electrodes 4 provided on the surface of the body 2.

In the following, a first primary face of the body 2, which is directed toward a mount substrate (not illustrated) when mounted, is defined as the bottom surface 10. A second primary face, which is opposite the bottom surface 10, is referred to as the upper surface 12, a pair of third primary faces, which are perpendicular to the bottom surface 10, are referred to as the end faces 14, and a pair of fourth primary faces, which are perpendicular to the bottom surface 10 and the pair of end faces 14, are referred to as the side faces 16.

As illustrated in FIG. 1, the distance from the bottom surface 10 to the upper surface 12 is defined as the thickness T of the body 2, the distance between the pair of side faces 16 is defined as the width W of the body 2, and the distance between the pair of end faces 14 is defined as the length L of the body 2. The direction along the thickness T, furthermore, is defined as the thickness direction DT, the direction along the width W is defined as the width direction DW, and the direction along the length distance is defined as the length direction DL.

As for the size of the inductor, the length L dimension is 2.0 mm, the width W dimension is 1.2 mm, and the thickness T dimension is 0.9 mm, for example.

FIG. 3 is a transparent perspective view illustrating the internal structure of the inductor.

The body 2 includes a coil conductor 20 and a core 30 in a substantially hexahedral shape in which the coil conductor 20 is embedded, and is configured as a molded inductor with the coil conductor 20 encapsulated in the core 30.

The core 30 is a molded body compressed and molded into a substantially hexahedral shape by pressing and heating a granulated powder containing metal magnetic particles and resin in a state in which the coil conductor 20 is encased in the granulated powder.

The metal magnetic particles include particles with two different particle sizes: first magnetic particles, which are larger particles and have a relatively large average particle diameter, and second magnetic particles, which are smaller particles and have a relatively small average particle diameter. By virtue of this, the second magnetic particles, which are the smaller particles, penetrate between the first magnetic particles, which are the larger particles, together with the resin during compression molding, thereby increasing the density of the metal magnetic particles in the core 30. This allows for an increase in magnetic permeability.

In this embodiment, the D50 particle diameters (median diameters) of the metal particles in the first magnetic particles and the second magnetic particles are 30 μm and 1.5 μm, respectively. It should be noted that the D50 particle diameter of the first magnetic particles is preferably 10 μm or more and 50 μm or less (i.e., from 10 μm to 50 μm), and the D50 particle diameter of the second magnetic particles is preferably 0.5 μm or more and 8 μm or less (i.e., from 0.5 μm to 8 μm), more preferably 1 μm or more and 5 μm or less (i.e., from 1 μm to 5 μm). The magnetic particles, furthermore, may include particles with three or more different particle sizes by including particles having an average particle diameter different from those of the first magnetic particles and the second magnetic particles.

The first magnetic particles and the second magnetic particles are both particles including metal particles and at least one insulating film covering their surface. By virtue of the metal particles being covered with at least one insulating film, insulation resistance and withstand voltage are increased.

The metal particles in the first magnetic particles and the second magnetic particles are, for example, Fe-based metal magnetic particles, such as Fe (pure iron) or at least one Fe alloy. An example for the Fe alloy can be one or more alloys selected from the group consisting of alloys containing Fe and Ni, alloys containing Fe and Co, alloys containing Fe and Si, alloys containing Fe, Si, and Cr, alloys containing Fe, Si, and Al, alloys containing Fe, Si, B, and C, alloys containing Fe, Si, B, and Cr, and alloys containing Fe, P, Cr, Si, B, Nb, and C.

The composition of the metal particles in the first magnetic particles and the composition of the metal particles in the second magnetic particles may be the same or may be different from each other.

The insulating film formed on the surface of the metal particles in the first magnetic particles and the second magnetic particles can be, for example, one or more insulating coatings selected from the group consisting of inorganic glass coatings, organic-inorganic hybrid coatings, and inorganic insulating coatings formed through sol-gel reactions of metal alkoxides.

In this embodiment, the first magnetic particles are made using Fe—Si—B—C amorphous alloy powder as the metal particles, and the second magnetic particles are made using pure iron as the metal particles.

The material for the resin in the granulated powder is preferably a thermosetting resin. By way of example, the resin in the granulated powder is a thermosetting epoxy resin.

The granulated powder will be further described later herein.

As illustrated in FIG. 3, the coil conductor 20 includes a wound portion 22, which is a wound lead wire, and a pair of extended portions 24, which are extended from the wound portion 22 with at least part of them exposed outside the body 2.

The coil conductor 20 is composed of a lead wire and a coating layer formed on the surface of the lead wire. The lead wire is a strip-shaped lead wire having a rectangular cross-section (so-called a flat rectangular lead wire) made of copper.

It should be noted that the coil conductor 20 does not necessarily need to be wound; it may be in, for example, a straight line shape or a meandering shape.

The wound portion 22 of the coil conductor 20 is formed by winding a strip-shaped lead wire (hereinafter also referred to simply as a lead wire) into a spiral shape in such a manner that both ends of the lead wire are extended to the outer circumference and connected to each other at the inner circumference. Inside the body 2, the coil conductor 20 is embedded in the core 30 in a position in which the central axis of the wound portion 22 is aligned with the direction DT along the thickness of the body 2. The extended portions 24 are extended from the wound portion 22 to each of the pair of end faces 14, with one of their primary faces exposed outside the body 2 and the other primary face embedded in the body 2. The primary faces of the extended portions 24 exposed outside the body 2 are electrically coupled to the outer electrodes 4.

The pair of outer electrodes 4 are so-called L-shaped electrodes, which are formed by L-shaped components extending from each of the end faces 14 of the body 2 to the bottom surface 10. The outer electrodes 4 are each coupled to the extended portions 24 of the coil conductor 20 at the end faces 14, and the portions 4A extending to the bottom surface 10 (FIG. 2) are electrically coupled to wiring on a circuit board using suitable mounting means, such as solder. It should be noted that the outer electrodes 4 are not limited to L-shaped electrodes as described above; they may have a so-called five-sided electrode structure or may be bottom electrodes.

On the surface of the body 2 excluding the areas of the outer electrodes 4, a body-protecting layer, which is an insulating film, has been formed. The body-protecting layer is, for example, an epoxy resin, a phenoxy resin, and a novolac resin and can be a material containing metal oxide fine particles as filler. In this embodiment, the body-protecting layer contains a silicon dioxide filler, which is to serve as metal oxide fine particles, and an epoxy resin. Besides these materials, the body-protecting layer may be a resin such as urethane, acrylic, polyimide, polyimide amide, or polyamide, or glass or an oxide film.

Inductors in such configurations, which allow for the improvement of DC superposition characteristics by virtue of the use of soft magnetic materials as the metal magnetic particles, are used as choke coils in electronic components for large-current electric circuits, DC-DC converter circuits, and power supply circuits. Such inductors, furthermore, are used in electronic components in electronic equipment such as PCs, DVD players, digital cameras, TV sets, mobile phones, smartphones, automotive electronics, and medical/industrial machinery. The applications of the inductors, however, are not limited to these; for example, the inductors can also be used in equipment such as tuned circuits, filter circuits, and rectifying and smoothing circuits.

### 1.2. Process for Manufacturing the Inductor

The inductor 1 can be fabricated, for example, as follows.

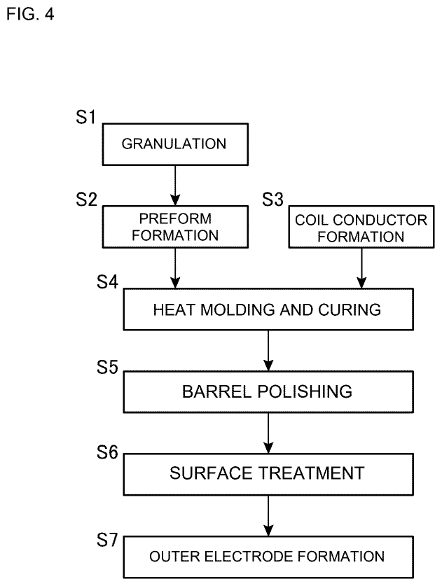

FIG. 4 is a diagram illustrating a process for manufacturing the inductor 1.

A process for manufacturing the inductor 1 can include a granulation step (S1), a preform formation step (S2), a coil conductor formation step (S3), a body molding step (S4), a barrel polishing step (S5), a surface treatment step (S6), and an outer electrode formation step (S7).

The granulation step (S1) is a step in which granulated powder is obtained by granulating a mixed powder as a mixture of the metal magnetic particles and resin that are to serve as the raw materials for the core 30. The details of the granulation step (S1) will be described later herein.

The preform formation step (S2) is a step in which at least one preform that is called a tablet is formed. The preform is the granulated powder described above, which is the material for the body 2, pressed in a mold and thereby molded into a solid form that is easy to handle. In this embodiment, two types of tablets are formed by way of example: a first tablet, which has a groove into which the coil conductor 20 is to enter and a cross-section in an E-shaped profile, and a second tablet, which covers the groove in this first tablet and has a cross-section in an I-shaped profile (plate shape).

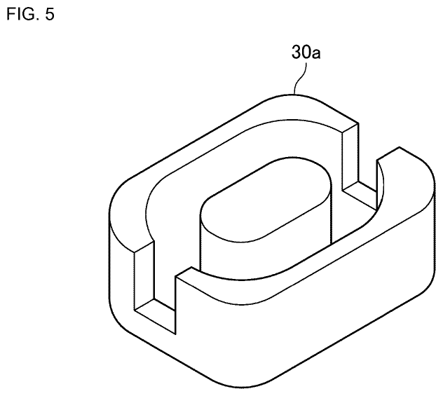

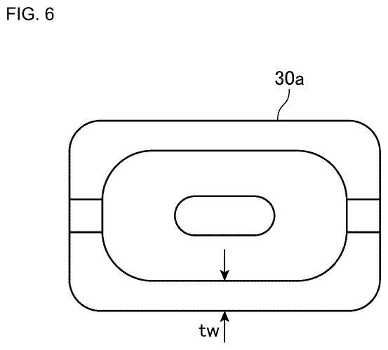

FIG. 5 and FIG. 6 are a perspective view and a plan view of the first tablet 30a, which has an E-shaped cross-sectional profile. In FIG. 6, the wall thickness tw on the lower side of the drawing, which is the thinnest portion of the first tablet 30a, is 150 μm. In other words, the width of the narrowest groove portion of the mold with which the first tablet 30a is formed is 150 μm. It should be noted that the shapes of the tablets are not limited to E-shaped profiles, which have three projecting portions, and I-shaped profiles, which have no projecting portion, like those described above; various shapes are possible, such as T-shaped profiles, which have one projecting portion in the middle portion of an I-shaped profile (plate shape), and shapes having a total of five projecting portions in the middle portion and at the four corners of an I-shaped profile (plate shape).

The coil conductor formation step (S3) is a step in which the coil conductor 20 is formed from a lead wire. The coil conductor 20 is formed by winding a lead wire, for example into a shape having an alpha-wound wound portion 22 and a pair of extended portions 24. It should be noted that, as mentioned above, the coil conductor 20 does not necessarily need to be wound; it may be in, for example, a straight line shape or a meandering shape.

In the body molding step (S4), the first tablet 30a, the coil conductor 20, and the second tablet are set in a mold for molding, and the first tablet 30a and the second tablet are cured by pressing them in the direction of their stacking while heating them, through which the first tablet, the coil conductor, and the second tablet are combined into a one-piece structure. Through this, a body 2 in which the coil conductor 20 is encased in the core 30 is molded.

In the barrel polishing step (S5), multiple bodies 2 are loaded into a drum, and the drum is rotated in such a manner that excessively strong impacts will not be applied. A coating solution that is to form the body-protecting layer, furthermore, is sprayed using a spray. Through this, the rounding of the corner portions of the bodies 2 and the application of the coating liquid to the bodies 2 are performed. After that, the bodies 2 with the coating solution applied to them are removed from the drum and heat-treated, through which the body-protecting layer is formed on the surface of the bodies 2.

It should be noted that the formation of the body-protecting layer is not limited to the foregoing; it can be one that is performed in a step separate from the barrel polishing step (S5) by various methods such as the spraying of the coating solution onto the bodies 2, the dipping of the bodies 2 into the coating solution, the feeding of the coating solution to the surface of the bodies 2 using a dispenser, and or the printing of a coating material onto the surface of the bodies 2 by different printing methods.

The surface treatment step (S6) is a step in which the surface of electrode formation regions on the surface of the core 30 is modified by irradiating the electrode formation regions with laser light. In this context, the electrode formation regions refer to the areas of the surface of the core 30 in which the outer electrodes 4 are to be formed, including the portions in which the extended portions 24 are exposed. Specifically, through irradiation with laser light, the body-protecting layer on the surface of the core 30 and the coating layer on the extended portions 24 of the coil conductor 20 are removed, along with the removal of the resin on the surface of the core 30 and the removal of the insulating film on the surface of the metal magnetic particles exposed outside the core 30, all within the areas of the electrode formation regions. Through this, in the portions of the surface of the core 30 corresponding to the electrode formation regions, the exposed area of the metal in the metal magnetic particles per unit area of the surface of the core 30 increases compared to that in the other surface portions of the core 30.

In the outer electrode formation step (S7), the outer electrodes 4 are formed in the electrode formation regions on the core 30. Specifically, a Cu plating layer is formed in the electrode formation regions on the core 30 by electrolytic plating first. Subsequently, a Ni plating layer and a Sn plating layer can be formed on the Cu plating layer by electrolytic plating.

### 2. Granulated Powder

The granulated powder used to form the core 30, which is the magnetic core of the inductor 1, will now be described.

As mentioned above, the characteristics and manufacturing variations of magnetic cores are influenced by the nature and condition of the granulated powder that is the raw material for the magnetic cores. For the conditions that the granulated powder needs to meet, it is particularly important that manufacturing stability in the shape of the magnetic cores after heating and pressure molding be good (i.e., manufacturing variations be small), and that the density of the magnetic cores produced from the granulated powder be high (i.e., the density of the metal magnetic particles be high).

The inventor conducted extensive research on the characteristics and conditions that the granulated powder should have from the above viewpoints, finding that a granulated powder in which the particle size distribution is homogeneous within a predetermined range of particle diameters and in which the curing reaction of resin during granulation has been inhibited (i.e., the curing reaction has yet to proceed) is suitable. Through this, the repeatability of the weight of the loaded granulated powder during the loading of the granulated powder into the mold and the flowability of the resin in the granulated powder during heating and pressing improve, manufacturing stability in the shape of the magnetic cores improves, and, the achievement of a higher density of the magnetic cores is enabled as well.

In the following, an embodiment and examples of granulated powders that enable the improvement of shape stability and the achievement of a higher density of magnetic cores will be described.

### 2.1. Embodiment of Granulated Powder

A granulated powder according to this embodiment contains granulated particles composed of metal magnetic particles and a thermosetting resin.

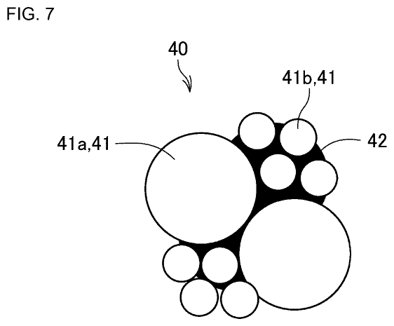

FIG. 7 is a schematic view illustrating the structure of the granulated particles 40 in the granulated powder according to this embodiment. The granulated particles 40 contained in the granulated powder are particles granulated using metal magnetic particles and a base ingredient and a curing agent in a predetermined weight ratio that are to form a thermosetting resin, and include metal magnetic particles 41 and a thermosetting resin 42. The metal magnetic particles 41 contain first magnetic particles 41a and second magnetic particles 41b with different average particle diameters. The average particle diameter of the second magnetic particles 41b is smaller than the average particle diameter of the first magnetic particles 41a.

The granulated particles 40 contained in the granulated powder have a D10 particle diameter of 15 μm or more and a D90 particle diameter of 150 μm or less. By virtue of this, the shape stability of the magnetic cores can be improved by improving the repeatability of the weight of the granulated powder loaded into the mold. For the granulated particles 40, it is preferred that the difference between the D90 particle diameter and the D10 particle diameter be 100 μm or more and 135 μm or less (i.e., from 100 μm to 135 μm), more preferably 110 μm or more and 130 μm or less (i.e., from 110 μm to 130 μm). The D90 particle diameter of the granulated particles 40, furthermore, is preferably 135 μm or less. With such preferred particle diameters, the repeatability of the weight of the granulated powder loaded into the mold can be further improved.

Moreover, as a measure indicating the progress of the curing reaction of the thermosetting resin 42 in the granulated powder, the Celsius temperature Tz for the granulated powder at which its heat flow peak in differential scanning calorimetry (DSC) is reached is such that the percentage decrease compared to the Celsius temperature Tg at which the resin immediately after the mixing of the base ingredient and the curing agent in the same predetermined weight ratio as in the production of the granulated powder reaches its heat flow peak in differential scanning calorimetry is 10% or less. By virtue of this, the flowability of the thermosetting resin 42 in the heating and pressing step during the production of the magnetic cores improves, and the weight density of the magnetic cores improves as a result of an increase in the density of the metal magnetic particles 41 in the magnetic cores. In this context, the “resin immediately after the mixing of the base ingredient and the curing agent in the same predetermined weight ratio as in the production of the granulated powder” refers to a resin in a state in which each of the base ingredient and the curing agent in the same predetermined weight ratio as in the production of the granulated powder has been dissolved in a diluting solvent, which will be described later herein, the resulting solutions have been mixed together, and the diluting solvents have volatilized immediately after that. In the following, the “resin immediately after the mixing of the base ingredient and the curing agent in the same predetermined weight ratio as in the production of the granulated powder” is referred to as “the same-composition resin.” A Celsius temperature at which a heat flow peak in differential scanning calorimetry is reached, furthermore, is referred to as a peak temperature.

### 2.2. Method for Manufacturing the Granulated Powder

In the following, a method for manufacturing the granulated powder according to this embodiment will be described.

The method for manufacturing granulated powder presented below can be implemented in, for example, the granulation step (S1) presented in the manufacturing process in FIG. 4.

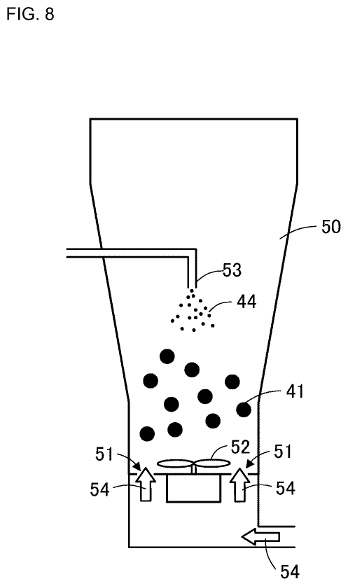

FIG. 8 is an explanatory view for describing a method for manufacturing the granulated powder according to an embodiment of the present disclosure.

The granulated powder can be produced by spraying a resin solution 44 of a thermosetting resin 42 while allowing a powder of metal magnetic particles 41 to flow inside a fluidized bed container 50.

Specifically, the fluidized bed container 50 is equipped with gas ports 51 and stirring blades 52 positioned in the bottom portion and a spray nozzle 53 positioned in the upper portion. In the manufacture of the granulated powder, a powder of metal magnetic particles 41 is placed in the fluidized bed container 50 first, and the stirring blades 52 are rotated while blowing gas 54 is blown in through the gas ports 51 to cause the powder to flow inside the fluidized bed container 50. In this state, a resin solution 44, which is a solution of a thermosetting resin 42, is sprayed onto the flowing powder through the spray nozzle 53. As a result of this, the powder of metal magnetic particles 41 is granulated with the sprayed resin solution 44 adhering to the metal magnetic particles 41, and is dried by the gas stream of the blowing gas 54 to yield granulated powder.

It should be noted that the fluidized bed container 50 in FIG. 8 is illustrated as a shape that is substantially cylindrical with the diameter of its lower portion tapering, but the shape of the fluidized bed container 50 can be any shape, provided that a resin solution 44 can be sprayed while a powder of metal magnetic particles 41 is caused to flow using blowing gas 54 and stirring blades 52. Besides cylindrical, the shape of such a fluidized bed container 50 can be, for example, drum-like or conical, or a shape that includes portions of such shapes in a mixed manner.

By way of example, the configuration of the metal magnetic particles 41, the composition of the resin solution 44, and other details are as follows.

The powder of metal magnetic particles 41 contains first magnetic particles 41a, which are larger particles, and second magnetic particles 41b, which are smaller particles. The first magnetic particles 41a are an Fe—Si—B—C alloy, and their D50 particle diameter is 28 μm. The second magnetic particles 41b are pure iron, and their D50 particle diameter is 1.5 μm. The weight ratio between the first magnetic particles 41a and the second magnetic particles 41b in the powder of metal magnetic particles 41 is the first magnetic particles 41a: the second magnetic particles 41b=75:25. In the Examples and Comparative Examples described later herein, a powder of metal magnetic particles in this configuration was used. For the weight ratio between the first magnetic particles 41a and the second magnetic particles 41b in the powder of metal magnetic particles 41, it is preferred that the first magnetic particles 41a: the second magnetic particles 41b be from 50:50 to 90:10.

The resin solution 44, furthermore, contains an epoxy resin, which is a thermosetting resin 42, as the base ingredient and imidazole as a curing agent, and contains acetone as a diluting solvent. The weight ratio between the base ingredient and the curing agent in the resin solution 44 is the base ingredient: the curing agent=97.4:2.6. In the Examples and Comparative Examples described later herein, a resin solution in this configuration was used. It should be noted that the diluting solvent is not limited to acetone and can be any solvent with which the base ingredient and the curing agent can be diluted. For example, other choices for the diluting solvent include ethanol, methanol, methyl ethyl ketone, methyl isobutyl ketone, ethyl acetate, isobutyl acetate, toluene, xylene, tetrahydrofuran, normal hexane, and cyclohexane.

The blowing gas 54 introduced through the gas ports 51 is, for example, a dry gas, with one example being nitrogen gas. The blowing gas 54, however, is not limited to nitrogen gas and can be any gas with which the powder of metal magnetic particles 41 can be caused to flow and with which the resin solution 44 adhering to the metal magnetic particles 41 can be dried. Such a gas may be, for example, a dry inert gas or dry air.

The flow rate of the blowing gas 54 introduced through the gas ports 51 is, for example, 100 L/min.

In the granulated powder manufactured as described above, the total weight percentage of the base ingredient and curing agent in the thermosetting resin 42 is preferably 2.0-5.0 wt %, more preferably 2.0-3.5 wt %, assuming that the total of the weight of the metal magnetic particles 41 and the weight of the base ingredient and curing agent in the thermosetting resin 42 in the granulated powder is 100 wt %. In the Examples and Comparative Examples described later herein, this total weight percentage was set to 3.0 wt %.

In this embodiment, the particle size distribution of the granulated powder to be manufactured and the progress of the curing reaction of the thermosetting resin 42 in the granulated powder are controlled by controlling, among others, the temperature of the blowing gas 54, the rotational frequency of the stirring blades 52 (stirring rotational frequency), the rate of delivery of the resin solution 44 through the spray nozzle 53, and the duration of the granulation process (granulation time) as granulation work conditions.

### 2.3. Examples of Granulated Powders

Multiple types of granulated powders varying in the particle size distribution of the granulated particles 40 in the granulated powder and the progress of the curing reaction of the thermosetting resin 42 contained in the granulated particles 40 were prepared. Using each granulated powder, first tablets 30a or ring-shaped molded bodies as samples were produced, and evaluations were performed.

### Evaluation of the Progress of the Curing Reaction of the Thermosetting Resin

First, an evaluation regarding the progress of the curing reaction of the thermosetting resin 42 contained in the granulated powder will be described.

The following evaluation was performed by preparing five types of granulated powders with similar particle size distributions of the granulated particles 40 and different degrees of progress of the curing reaction of the thermosetting resin 42. Of the five types of granulated powders, three are examples of this embodiment, and the remaining two are comparative examples in which the curing reaction of the thermosetting resin 42 proceeded to a greater extent.

The control of the progress of the curing reaction of the thermosetting resin 42 in these examples and comparative examples was performed by controlling the temperature of the blowing gas 54 and the granulation time among the granulation conditions in the manufacturing method described above.

As mentioned above, as a measure indicating the progress of the curing reaction of the thermosetting resin 42 in the granulated powder, the percentage decrease in the peak temperature Tz in differential scanning calorimetry for the granulated powder compared to the peak temperature Tg of the same-composition resin in differential scanning calorimetry was used. This percentage decrease is hereinafter referred to as the percentage decrease in peak temperature.

Specifically, the percentage decrease in peak temperature is calculated according to equation (1) below using the peak temperature Tz of the granulated powder and the peak temperature Tg of the same-composition resin.

$$Percentage decrease in peak temperature ( \% ) = ( 1 - Tz / Tg ) \times 100 \qquad ( 1 )$$

In this evaluation, a 2-mg sample for measurement was randomly extracted from each of the same-composition resin and the aforementioned five types of granulated powders, and the peak temperatures were measured using a differential scanning calorimeter (DSC6200, manufactured by Seiko Instruments Inc.). As for the measurement conditions, the measuring gas is nitrogen (N₂), the gas flow rate is 30 ml/min, the temperature increase rate is 100° C./min, and the measurement temperature range is from 0° C. to 250° C.

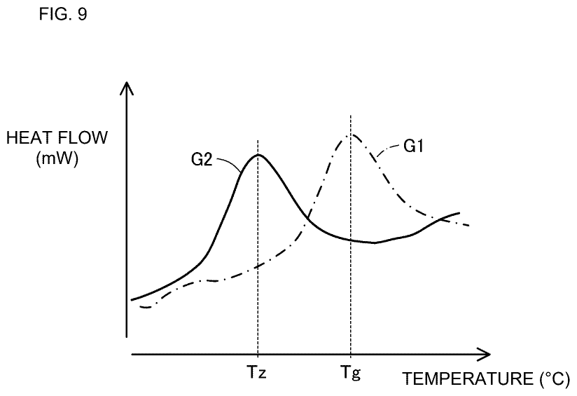

FIG. 9 is a graph schematically illustrating the DSC curves to be measured. In FIG. 9, the horizontal axis is temperature (° C.), and the vertical axis is heat flow (mW). Curve G1 is the DSC curve of the same-composition resin, and curve G2 is the DSC curve of the granulated powder.

The curing reactions of thermosetting resins are exothermic reactions. In the granulated particles, compared to the same-composition resin, the curing reaction of the thermosetting resin 42 has proceeded to some extent during the course of granulation. Thus the peak temperature Tz that curve G2, the DSC curve of the granulated powder, indicates is a lower temperature than the peak temperature Tg that curve G1, the DSC curve of the same-composition resin, indicates. The greater the progress of the curing reaction of the thermosetting resin 42, the larger the difference between Tg and Tz that appears. The greater the progress of the curing reaction of the thermosetting resin 42, therefore, the larger the percentage decrease in peak temperature (%) calculated according to equation (1) above.

Using the aforementioned five types of granulated powders, twenty ring-shaped molded bodies each were produced as test specimens for each type of granulated powder, and the density and specific magnetic permeability of each molded body were evaluated. The ring-shaped molded bodies were produced at a molding temperature of 190° C., a molding pressure of 2.4 kN, and a molding time of 180 seconds using a mold with an outer diameter of 13 mm and an inner diameter of 8 mm. The density of the ring-shaped molded bodies was calculated from the dimensions and weight of the ring-shaped molded bodies. As the specific magnetic permeability of the ring-shaped molded bodies, furthermore, the specific magnetic permeability at 1 MHz was measured using an impedance analyzer.

The evaluation results are presented in Table 1. It should be noted that in Examples 1, 2, and 3 and Comparative Examples 1 and 2, the granulated particles contained in the granulated powder were ones having a D10 particle diameter of 15 μm or more and 20 μm or less (i.e., from 15 μm to 20 μm) and a D90 particle diameter of 100 μm or more and 110 μm or less (i.e., from 100 μm to 110 μm). The granulation conditions in Examples 1, 2, and 3 and Comparative Examples 1 and 2, furthermore, were the same conditions (stirring rotational frequency, 300 rpm; delivery rate, 20 g/min) as in Example 4 described later herein, except for the temperature of the blowing gas 54 and the granulation time, which are specified in Table 1. The inventor has confirmed that the weight variations among the molded bodies have been narrowed through this, with the CV values for molded body weights, which indicate weight variations, for the twenty molded bodies in each of Examples 1, 2, and 3 and Comparative Examples 1 and 2 being all 0.006 or less in a measurement performed in the same manner as in Example 4, which will be described later. The specific magnetic permeability presented in Table 1, furthermore, is the average of the specific magnetic permeabilities of the twenty molded bodies in each of Examples 1, 2, and 3 and Comparative Examples 1 and 2.

TABLE 1

| | Blowing | | Percentage | | | |
|---|---|---|---|---|---|---|
| | gas | Granulation | decrease in | Molded | Density | |
| | temperature | time | peak temperature | body density | CV | Magnetic |
| | (° C.) | (min) | (%) | (g/ml) | value | permeability |
| Example 1 | 25 | 240 | 2.9 | 6.22 | 0.002 | 35.4 |
| Example 2 | 45 | 120 | 7.8 | 6.22 | 0.002 | 35.8 |
| Example 3 | 45 | 240 | 10.0 | 6.21 | 0.001 | 34.7 |
| Comparative | 55 | 160 | 11.2 | 6.16 | 0.002 | 33.6 |
| Example 1 | | | | | | |
| Comparative | 55 | 240 | 12.8 | 6.10 | 0.008 | 31.7 |
| Example 2 | | | | | | |

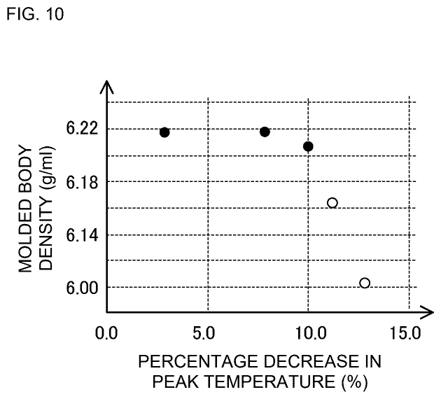

FIG. 10 is a graph in which the relationship between the percentage decrease in peak temperature and the molded body density is plotted based on the results in Table 1. In FIG. 10, the black circles are plots for the three examples, and the white circles are plots for the two comparative examples. As shown in FIG. 10, in the three examples, in which the percentage decrease in peak temperature is 10% or less, the ring-shaped molded bodies are produced with a high density within the range of 6.20 to 6.22 g/ml. In the two comparative examples, in which the percentage decrease in peak temperature percentage exceeds 10%, the molded body density sharply decreases with increasing percentage decrease in peak temperature.

The density of a molded body indicates the quantity of metal magnetic particles 41 contained in a unit volume of the molded body. The higher the density of the molded body, the greater the number of metal magnetic particles 41 contained in a unit volume, and the greater the value of the specific magnetic permeability.

The inventor believes that the sharp decrease in molded body density with increasing percentage decrease in peak temperature like that shown in FIG. 10 is due to the fact that as the curing reaction of the thermosetting resin 42 in the granulated powder proceeds, the flowability of the thermosetting resin 42 during the production of the molded bodies through the heating and pressing of the granulated powder becomes lower. For example, as a result of the lowered flowability of the thermosetting resin 42, outcomes such as inhibited discharge of excess thermosetting resin 42 through gaps in the mold for molding during the production of the molded bodies are possible.

From the evaluation results presented in Table 1 and FIG. 10, it can be understood that by restricting the progress of the curing reaction of the thermosetting resin 42 contained in the granulated powder to the range in which the percentage decrease in peak temperature is 10% or less, the density of molded bodies produced using the granulated powder can be increased.

### Evaluation of the Particle Size Distribution of the Granulated Particles

An evaluation regarding the particle size distribution of the granulated particles 40 in the granulated powder will now be described.

The following evaluation was performed by preparing seven types of granulated powders with similar degrees of progress of the curing reaction of the thermosetting resin 42 in the granulated powder and different particle size distributions of the granulated particles 40. Of the seven types of granulated powders, five are examples of this embodiment, and the remaining two are comparative examples in which the particle size distribution is outside the range specified in the embodiment described above.

The control of the particle size distribution in these examples and comparative examples was performed by controlling the stirring rotational frequency of the stirring blades 52 and the rate of delivery of the resin solution 44 through the spray nozzle 53 among the granulation conditions in the manufacturing method described above.

The particle size distribution of the granulated particles 40 in each type of granulated powder was measured in EKINEN solvent using a particle size distribution analyzer (MT3300, manufactured by MicrotracBEL Corporation) based on laser diffraction scattering.

Using the aforementioned seven types of granulated powders, twenty molded body samples each were prepared for each type of granulated powder. The molded bodies are in the same shape as the first tablet 30a as a preform illustrated in FIG. 6. For the total of 140 molded bodies, the same preform mold was used. The width of the narrowest portion of the preform mold is 150 μm (the portion corresponding to the wall thickness tw in FIG. 6, described earlier herein).

Molded bodies in the same shape as the first tablet 30a were obtained by loading the granulated powder into a preform mold with any excess leveled off and then pressing the powder while heating it. The conditions for heating and pressing are a temperature of 190° C., a pressure of 2.4 kN, and a duration of 180 seconds. The weight of the twenty molded bodies each in each example and each comparative example was measured, and their CV value (=standard deviation/mean) was calculated.

The evaluation results are presented in Table 2. It should be noted that the granulation conditions for the granulated powders in Examples 4, 5, 6, 7, and 8 and Comparative Examples 3 and 4 were the same conditions (blowing gas temperature, 25° C.; granulation time, 240 minutes) as in Example 1 described above, except for the stirring rotational frequency of the stirring blades 52 and the rate of delivery of the resin solution 44 through the spray nozzle 53, which are specified in Table 2. The inventor has confirmed that the molded bodies have been controlled to a density of 6.20 g/ml or more through this, with the percentage decrease in peak temperature for the twenty molded bodies in each of Examples 4, 5, 6, 7, and 8 and Comparative Examples 3 and 4 being in the range of 2.8% to 3.2%.

TABLE 2

| | | | Particle | | | |
|---|---|---|---|---|---|---|
| | | | diameters of | | Span of | Variations |
| | Granulation work conditions | | the granulated | | particle | in molded |
| | Stirring | Rate of delivery | powder | | diameters | body |
| | rotational | of the resin | D10 | D90 | D90-D10 | weight |
| | frequency (rpm) | (g/min) | (μm) | (μm) | (μm) | CV value |
| Comparative | 500 | 20 | 11.9 | 100.1 | 88.2 | 0.015 |
| Example 3 | | | | | | |
| Example 4 | 300 | 20 | 15.0 | 109.2 | 94.2 | 0.005 |
| Example 5 | 180 | 20 | 21.0 | 106.6 | 85.6 | 0.004 |
| Example 6 | 200 | 20 | 19.5 | 113.2 | 93.7 | 0.005 |
| Example 7 | 200 | 30 | 19.7 | 123.5 | 103.8 | 0.006 |
| Example 8 | 200 | 40 | 20.5 | 150.0 | 129.5 | 0.006 |
| Comparative | 200 | 50 | 19.9 | 167.2 | 147.3 | 0.014 |
| Example 4 | | | | | | |

As shown in Table 2, in Comparative Examples 3 and 4, weight variations are great, with the CV values for molded body weight exceeding 0.01. In Examples 4, 5, 6, 7, and 8, by contrast, weight variations have been restricted, with the CV values for molded body weight being 0.006 or less. Through evaluations conducted afterwards, it has been confirmed that when the CV value for preform weight is limited to 0.006 or less, the yield of the shape of bodies (i.e., the shape of magnetic cores) produced through the body molding step (S4) using those preforms falls within its allowable limits.

From the evaluation results presented in Table 2, it can be understood that by ensuring that the particle size distribution of the granulated particles 40 contained in the granulated powder is in the range in which the D10 particle diameter is 15 μm or more and in which the D90 particle diameter is 150 μm or less, the repeatability of the weight of the granulated powder loaded into the mold can be improved.

It should be noted that all the embodiments and examples described above illustrate one aspect of the present disclosure, and any modifications and applications are possible without departing from the spirit of the present disclosure.

In addition, unless otherwise specified, the directions, such as the horizontal and vertical directions, and the various numerical values, shapes, and materials in the embodiments described above include ranges in which the same advantages as those of the directions, numerical values, shapes, and materials are achieved (so-called equivalent ranges).

### 3. Configurations Supported by the Embodiments and Examples

The embodiments and examples described above support the following configurations.

(Configuration 1) A granulated powder containing granulated particles granulated using metal magnetic particles and a base ingredient and a curing agent in a predetermined weight ratio that are to form a thermosetting resin, wherein the metal magnetic particles include first magnetic particles and second magnetic particles with different average particle diameters, the granulated particles contained in the granulated powder have a D10 particle diameter of 15 μm or more and a D90 particle diameter of 150 μm or less, and a percentage decrease in a Celsius temperature at which the granulated powder reaches a heat flow peak in differential scanning calorimetry compared to a Celsius temperature at which a resin immediately after mixing of the base ingredient and the curing agent in the predetermined weight ratio reaches a heat flow peak in differential scanning calorimetry is 10% or less.

With the granulated powder in configuration 1, the repeatability of the weight of granulated powder loaded into a mold for molded bodies can be improved, and the density of molded bodies produced through the heating and pressure molding of granulated powder inside a mold can be improved at the same time.

(Configuration 2) The granulated powder according to configuration 1, wherein for the granulated particles, a difference between the D90 particle diameter and the D10 particle diameter is 100 μm or more and 135 μm or less (i.e., from 100 μm to 135 μm).

With the granulated powder in configuration 2, the repeatability of the weight of granulated powder loaded into a mold for molded bodies can be further improved.

(Configuration 3) The granulated powder according to configuration 1, wherein for the granulated particles, a difference between the D90 particle diameter and the D10 particle diameter is 110 μm or more and 130 μm or less (i.e., from 110 μm to 130 μm).

With the granulated powder in configuration 3, the repeatability of the weight of granulated powder loaded into a mold for molded bodies can be improved to an even higher degree.

(Configuration 4) The granulated powder according to configuration 1, wherein the granulated particles have a D90 particle diameter of 135 μm or less.

With the granulated powder in configuration 4, the repeatability of the weight of granulated powder loaded into a mold for molded bodies can be improved to a still higher degree.

(Configuration 5) The granulated powder according to any of configurations 1 to 4, wherein a weight proportion of the thermosetting resin to a total weight of the metal magnetic particles and the thermosetting resin is 3.5% by weight or less.

With the granulated powder in configuration 5, molded bodies with a high density can be produced through the heating and pressure molding of the granulated powder inside a mold.

(Configuration 6) The granulated powder according to any of configurations 1 to 5, wherein the thermosetting resin is an epoxy resin.

With the granulated powder in configuration 6, molded bodies with a higher density can be produced through the heating and pressure molding of the granulated powder inside a mold.

### (Configuration 7)

An inductor including a molded body produced by pressure-molding the granulated powder according to any of configurations 1 to 6, a coil conductor embedded in the molded body, and a pair of outer electrodes electrically coupled to the coil conductor.

According to configuration 7, an inductor with high manufacturing stability in the shape of a molded body and high density of the molded body can be realized.

What is claimed is:

1. A granulated powder comprising:
granulated particles granulated using metal magnetic particles and a base ingredient and a curing agent in a predetermined weight ratio that are to configure a thermosetting resin, wherein:
the metal magnetic particles include first magnetic particles and second magnetic particles with different average particle diameters;
the granulated particles included in the granulated powder have a D10 particle diameter of 15 μm or more and a D90 particle diameter of 150 μm or less; and
a percentage decrease in a Celsius temperature at which the granulated powder reaches a heat flow peak in differential scanning calorimetry compared to a Celsius temperature at which a resin immediately after mixing of the base ingredient and the curing agent in the predetermined weight ratio reaches a heat flow peak in differential scanning calorimetry is 10% or less.

2. The granulated powder according to claim 1, wherein:
for the granulated particles, a difference between the D90 particle diameter and the D10 particle diameter is from 100 μm to 135 μm.

3. The granulated powder according to claim 1, wherein:
for the granulated particles, a difference between the D90 particle diameter and the D10 particle diameter is from 110 μm to 130 μm.

4. The granulated powder according to claim 1, wherein:
the granulated particles have a D90 particle diameter of 135 μm or less.

5. The granulated powder according to claim 1, wherein:
a weight proportion of the thermosetting resin to a total weight of the metal magnetic particles and the thermosetting resin is 3.5% by weight or less.

6. The granulated powder according to claim 1, wherein:
the thermosetting resin is an epoxy resin.

7. An inductor comprising:
a molded body produced by pressure-molding the granulated powder according to claim 1;
a coil conductor embedded in the molded body; and
a pair of outer electrodes electrically coupled to the coil conductor.

8. An inductor comprising:
a molded body produced by pressure-molding the granulated powder according to claim 2;
a coil conductor embedded in the molded body; and
a pair of outer electrodes electrically coupled to the coil conductor.

9. An inductor comprising:
a molded body produced by pressure-molding the granulated powder according to claim 3;
a coil conductor embedded in the molded body; and
a pair of outer electrodes electrically coupled to the coil conductor.

10. An inductor comprising:
a molded body produced by pressure-molding the granulated powder according to claim 4;
a coil conductor embedded in the molded body; and
a pair of outer electrodes electrically coupled to the coil conductor.

11. An inductor comprising:
a molded body produced by pressure-molding the granulated powder according to claim 5;
a coil conductor embedded in the molded body; and
a pair of outer electrodes electrically coupled to the coil conductor.

12. An inductor comprising:
a molded body produced by pressure-molding the granulated powder according to claim 6;
a coil conductor embedded in the molded body; and
a pair of outer electrodes electrically coupled to the coil conductor.
